(19) United States
(12) Patent Application Publication
(10) Pub. No.: US 2020/0224760 A1
(43) Pub. Date: Jul. 16, 2020

(54) VEHICLE INCLUDING A KNIT ELEMENT CONNECTING A FIRST VEHICLE MEMBER TO A SECOND VEHICLE MEMBER

(71) Applicant: GM GLOBAL TECHNOLOGY OPERATIONS LLC, DETROIT, MI (US)

(72) Inventors: Judith H. Clark, Hartland, MI (US); Janet C. Robincheck, Sterling Heights, MI (US); David Helmer, Clawson, MI (US); Toni A. Rosa, Clarkston, MI (US)

(21) Appl. No.: 16/244,201

(22) Filed: Jan. 10, 2019

(51) Int. Cl. F16H 59/02; G05G 25/04; B60K 20/04; D04B 39/00

(52) U.S. Cl. CPC F16H 59/0213; G05G 25/04; B62D 1/16; D04B 39/00; B60K 20/04

(57) ABSTRACT

A vehicle includes a first vehicle member, a second vehicle member, and a knit element connected to the first vehicle member and the second vehicle member.

### FIELD

The present disclosure relates to a vehicle including a knit element connecting a first vehicle member to a second vehicle member.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Vehicles may include flexible elements such as a steering-column close out and/or a shift boot. FIG. 1 illustrates a perspective view of a vehicle interior including a transmission gear shift selector 100 (hereinafter “shifter”) and a shift boot 102 which flexibly covers and/or encloses the volume between the shifter 100 and the underlying central console 104. FIG. 2 illustrates a perspective view of a vehicle interior including a steering column 200 with a steering column close out 202 that covers and/or encloses the volume between the steering column 200 and an instrument panel 204. The motion of the steering column and/or shifter causes the steering column close out or shift boot to move, flex, and bend. Each movement may fatigue the material of the close out or shift boot which may increase the chance of those elements failing by, for example, cracking. In colder weather, these elements tend to get stiffer and are even more at risk of cracking. Additionally, the motion of the shift boot and/or close out may generate noise as it contacts other elements of the vehicle. It is desirable to provide a vehicle having elements which may be used, for example, as a steering column close out and/or a shift boot which has a reduced potential to fail and which reduces the potential for generating noise during movement.

### SUMMARY

In an exemplary aspect, a vehicle includes a first vehicle member, a second vehicle member, and a knit element connected to the first vehicle member and the second vehicle member.

In another exemplary aspect, the first vehicle member includes a steering column and the second vehicle member includes an instrument panel.

In another exemplary aspect, the first vehicle member includes a shifter and the second vehicle member includes a trim plate.

In another exemplary aspect, the knit element comprises a heat reactive yarn.

In another exemplary aspect, the heat reactive yarn is incorporated only in a portion of the knit element.

In another exemplary aspect, the knit element forms a shift boot and the heat reactive yarn is incorporated in a lower portion of the shift boot.

In another exemplary aspect, the heat reactive yarn includes a heat fused yarn and a first portion of the knit element incorporating the heat fused yarn has an increased stiffness than a second portion of the knit element that does not incorporate the heat fused yarn.

In another exemplary aspect, the knit element is produced by a knitting process.

In another exemplary aspect, the knitting process includes knitting a heat reactive yarn into a portion of the knit element.

In another exemplary aspect, the knit element is further produced by heating the knit element.

In another exemplary aspect, the knit element is further produced by positioning the knit element on a shaping fixture prior to heating the knit element.

In another exemplary aspect, the knitting process includes knitting a connecting element into the knit element.

In another exemplary aspect, one of the first vehicle member and the second vehicle member includes a hook and the connecting element in the knit element includes a tab defining a hole that receives the hook.

In another exemplary aspect, the knitting process includes knitting a tube in a portion of the knit element.

In another exemplary aspect, the knit element is further produced by turning the knit element inside-out to form a hook shape in a portion of the knit element.

In another exemplary aspect, a method of producing a knit element for a vehicle for connecting a first vehicle member to a second vehicle member, the method includes knitting the knit element.

In another exemplary aspect, the knitting includes a flat-bed knitting process.

In another exemplary aspect, the method further includes knitting a heat reactive yarn into a portion of the knit element.

In another exemplary aspect, the method further includes heating the heat reactive yarn in the knit element.

In another exemplary aspect, the knitting process includes knitting a connecting element into the knit element.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view of a vehicle interior including shifter and a shift boot which flexibly covers and/or encloses the volume between the shifter and the underlying central console;

FIG. 2 is a perspective view of a vehicle interior including a steering column with a steering column close out that covers and/or encloses the volume between the steering column and an instrument panel;

FIG. 3 is a perspective view of an exemplary embodiment of a shift boot in accordance with the present disclosure;

FIG. 4 is a perspective view of another exemplary embodiment of a shift boot in accordance with the present disclosure;

FIG. 5 is a perspective view of another exemplary embodiment of a shift boot in accordance with the present disclosure;

FIG. 6 is a perspective view of another exemplary embodiment of a shift boot in accordance with the present disclosure; and

FIG. 7 is another perspective view of the shift boot of FIG. 6.

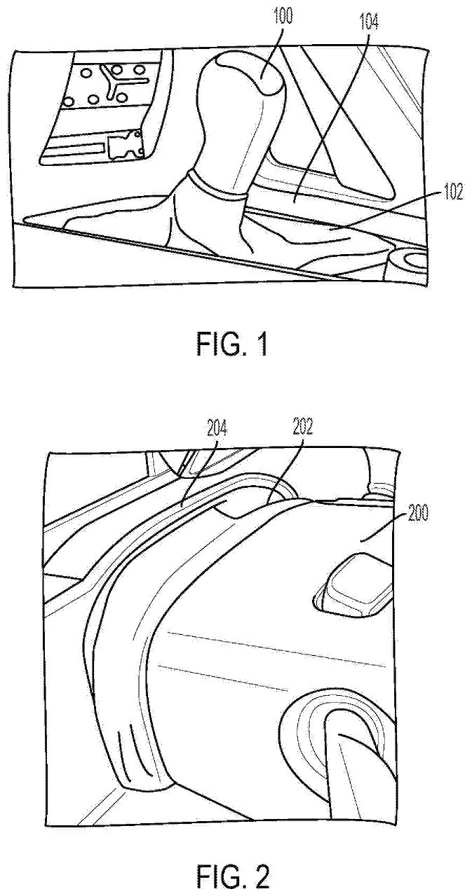

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

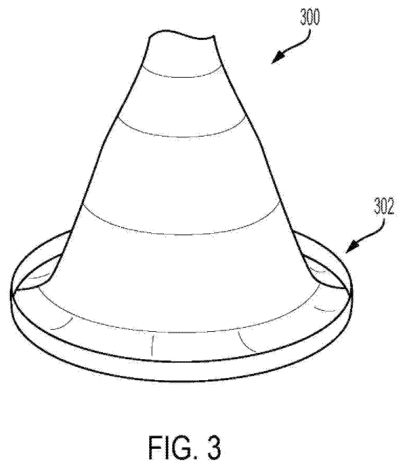

FIG. 3 is a perspective view of an exemplary embodiment of a shift boot 300 in accordance with the present disclosure. The shift boot 300 is composed of a knit fabric in which a reactive/heat reactive yarn has been incorporated in a lower portion 302. After knitting, the shift boot 300 may be exposed to a heat source such that the heat reactive yarn reacts and holds a shape. Preferably, the shift boot 300 may be positioned over a fixture which holds the shift boot 300 in a desired shape during the heating process. The heat reacted lower portion 302 of the shift boot 300 may then more easily be attached to another portion of the vehicle, such as, for example, a central console in which a shifter is positioned.

The reactive/heat reactive yarn may also be incorporated into the knit structure of the shift boot 300 such that when reacted with heat, the heat reacted yarn provides an increased strength and, thus, an increased stiffness to the boot 300 in areas where the heat reactive yarn is incorporated. Further, the degree and amount of heat reactive yarn incorporated into the knit structure may be varied across the boot 300.

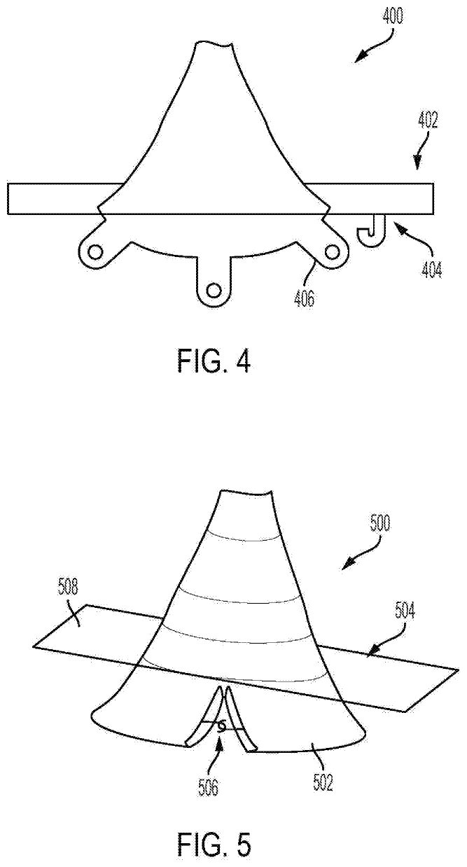

FIG. 4 is a perspective view of another exemplary embodiment of a shift boot 400 in accordance with the present disclosure. FIG. 4 further illustrates a trim plate 402 which may be attached to the shift boot 400. The trim plate 402 includes a hook 404 which may be selectively connected to a tab 406 which has been knit into the structure of the shift boot 400. In this manner, the shift boot 400 may incorporate connecting elements, such as the tab 406, which may selectively engage with corresponding elements in a trim plate 402 to connect the shift boot 400 to the trim plate 402 in an easy to assemble manner and without requiring additional parts. While the exemplary embodiment illustrated in FIG. 4 includes a hook 404, it is to be understood that any connector may be used, such as, for example, a clip, fastener, or similar connector, and still remain within the scope of the present disclosure.

FIG. 5 is a perspective view of another exemplary embodiment of a shift boot 500 in accordance with the present disclosure. This shift boot 500 is composed of a knit fabric which incorporates a knit tube 502 at a lower portion 504 of the boot 500. The shift boot 500 further includes connection features such as hooks 506 which have been integrated into the boot 500 during knitting of the shift boot 500. In this manner, the shift boot 500 may incorporate connecting elements, such as the hooks 506, which may selectively engage with each other to connect the shift boot 500 to the trim plate 508 in an easy to assemble manner and without requiring additional parts. Although not illustrated, it is to be understood that the shift boot 500 may also incorporate these connecting elements at an upper portion for easy assembly and connection to a shifter. While the exemplary embodiment illustrated in FIG. 5 include hooks 506, it is to be understood that any connector may be used, such as, for example, a clip, fastener, or similar connector, and still remain within the scope of the present disclosure.

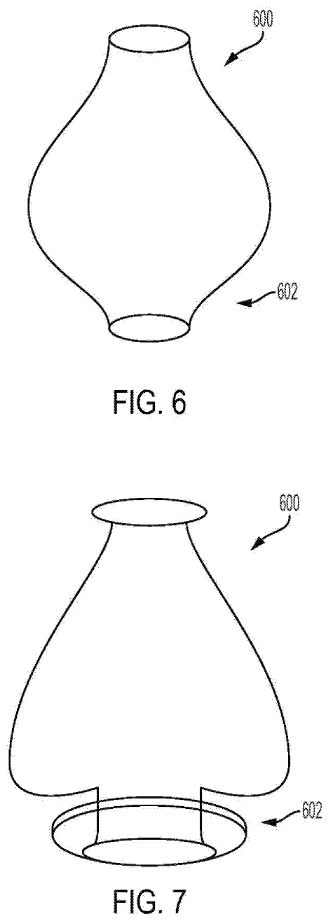

FIG. 6 is a perspective view of another exemplary embodiment of a shift boot 600 in accordance with the present disclosure. During manufacture, the shift boot 600 may be knit in a manner where the boot 600 is inside out (as illustrated in FIG. 6) from the configuration in which it will ultimately be installed in a vehicle. FIG. 7 illustrates another perspective view of the shift boot 600 which has been turned “right side out.” Upon turning “right side out” the lower portion 602 of the boot 600 forms a hook shape. In this manner, the shift boot 600 may incorporate connecting elements, such as the tab hook shape in the lower portion 602, which may selectively engage with a corresponding connecting element (not shown) to install the shift boot 600 into the vehicle in an easy to assemble manner and without requiring additional parts.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A vehicle comprising:
a first vehicle member;
a second vehicle member, and
a knit element connected to the first vehicle member and the second vehicle member.

2. The vehicle of claim 1, wherein the first vehicle member comprises a steering column and the second vehicle member comprises an instrument panel.

3. The vehicle of claim 1, wherein the first vehicle member comprises a shifter and the second vehicle member comprises a trim plate.

4. The vehicle of claim 1, wherein the knit element comprises a heat reactive yarn.

5. The vehicle of claim 4, wherein the heat reactive yarn is incorporated only in a portion of the knit element.

6. The vehicle of claim 5, wherein the knit element forms a shift boot and wherein the heat reactive yarn is incorporated in a lower portion of the shift boot.

7. The vehicle of claim 4, wherein the heat reactive yarn comprises a heat fused yarn and wherein a first portion of the knit element incorporating the heat fused yarn has an increased stiffness than a second portion of the knit element that does not incorporate the heat fused yarn.

8. The vehicle of claim 1, wherein the knit element is produced by a knitting process.

9. The vehicle of claim 8, wherein the knitting process comprises knitting a heat reactive yarn into a portion of the knit element.

10. The vehicle of claim 9, wherein the knit element is further produced by heating the knit element.

11. The vehicle of claim 10, wherein the knit element is further produced by positioning the knit element on a shaping fixture prior to heating the knit element.

12. The vehicle of claim 8, wherein the knitting process comprises knitting a connecting element into the knit element.

13. The vehicle of claim 12, wherein one of the first vehicle member and the second vehicle member comprises a connector and wherein the connecting element in the knit element comprises a tab defining a hole that receives the connector.

14. The vehicle of claim 8, wherein the knitting process comprises knitting a tube in a portion of the knit element.

15. The vehicle of claim 8, wherein the knit element is further produced by turning the knit element inside-out to form a hook shape in a portion of the knit element.

16. A method of producing a knit element for a vehicle for connecting a first vehicle member to a second vehicle member, the method comprising knitting the knit element.

17. The method of producing the knit element of claim 16, wherein the knitting comprises a flat-bed knitting process.

18. The method of claim 16, further comprising knitting a heat reactive yarn into a portion of the knit element.

19. The method of claim 18, further comprising heating the heat reactive yarn in the knit element.

20. The method of claim 16, wherein the knitting process comprises knitting a connecting element into the knit element.
